(19) United States
(12) Patent Application Publication
(10) Pub. No.: US 2025/0030806 A1
(43) Pub. Date: Jan. 23, 2025

(54) IMAGE FORMING APPARATUS THAT CHANGES PERIOD OF TIME REQUIRED TO TRANSITION FROM FIRST POWER STATE TO SECOND POWER STATE WHEN IMAGE FORMING APPARATUS IS NO LONGER USED

(71) Applicant: KYOCERA Document Solutions Inc., Osaka (JP)

(72) Inventor: Yukihiro SHIBATA, Osaka (JP)

(73) Assignee: KYOCERA Document Solutions Inc., Osaka (JP)

(21) Appl. No.: 18/765,352

(22) Filed: Jul. 8, 2024

(30) Foreign Application Priority Data
Jul. 18, 2023 (JP) 2023-116739

(51) Int. Cl. H04N 1/00

(52) U.S. Cl. CPC H04N 1/00896; H04N 1/00037; H04N 1/00087

(57) ABSTRACT

An image forming apparatus includes a detection device, a reception device, and a control device that functions as a determination device and a changing device. The detection device detects a detection target. The reception device receives an operation from the detection target and generates operation information. The operation information includes end information regarding end of the operation. The determination device determines whether use of the image forming apparatus has ended based on the end information and a detection result of the detection device. When the determination device determines that the use of the image forming apparatus has ended, the changing device changes a first period of time, which is required to transition from a first power state to a second power state in which less power is consumed than in the first power state, to a second period of time which is shorter than the first period of time.

### INCORPORATION BY REFERENCE

This application claims priority to Japanese Patent Application No. 2023-116739 filed on 18 Jul. 2023, the entire contents of which are incorporated by reference herein.

### BACKGROUND

The disclosure relates to an image forming apparatus.

In general, an image forming apparatus operates in a first power state and a second power state that is more power-efficient than the first power state. The image forming apparatus includes a detection unit and a control unit. The detection unit detects an object. The control unit shifts the image forming apparatus to the second power state when the detection unit changes to a state in which it does not detect an object.

### SUMMARY

As an aspect of the disclosure, technology obtained by further improving the above-described technology is proposed.

An image forming apparatus according to an aspect of the disclosure is an image forming apparatus capable of switching a state of the image forming apparatus between a first power state and a second power state in which less power is consumed than in the first power state, and includes a detection device, a reception device, and a control device. The detection device detects a detection target. The reception device receives an operation from the detection target and generates operation information indicating an operation content of the detection target. The control device includes a processor and functions as a determination device and a changing device by the processor executing a control program. The determination device determines whether use of the image forming apparatus has ended. The changing device changes a first period of time, which is required to transition from the first power state to the second power state, to a second period of time that is shorter than the first period of time. The operation information includes end information regarding end of the operation. The determination device determines whether the use of the image forming apparatus has ended based on the end information and a detection result of the detection device. When the determination device determines that the use of the image forming apparatus has ended, the changing device changes the first period of time to the second period of time.

### BRIEF DESCRIPTION OF THE DRAWINGS

FIG. 1 is a diagram showing a configuration of an image forming apparatus.

FIG. 2 is a block diagram showing the image forming apparatus.

FIG. 3 is a flowchart showing processing executed by the image forming apparatus.

FIG. 4 is a flowchart showing determination processing executed by the image forming apparatus.

### DETAILED DESCRIPTION

An embodiment of the disclosure will be described below with reference to the drawings. Further, in the drawings, the same reference numerals are given to the same or corresponding parts, and the description thereof will not be repeated.

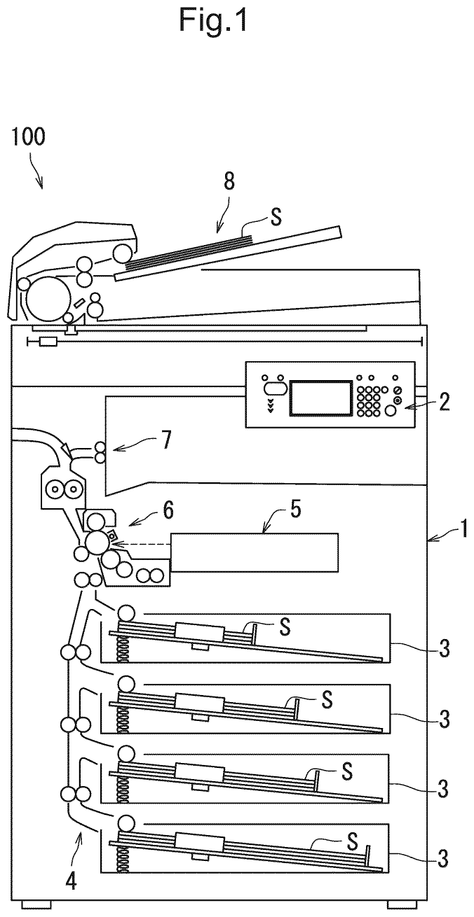

A configuration of an image forming apparatus 100 according to the present embodiment will be described with reference to FIG. 1. FIG. 1 is a diagram showing the configuration of an image forming apparatus 100. The image forming apparatus 100 forms images.

The image forming apparatus 100 can switch between a first power state and a second power state. The first power state is a state in which the image forming apparatus 100 can form an image. The second power state is a state in which power consumption is lower than in the first power state.

The image forming apparatus 100 includes a housing 1, a paper feeding device 3, a conveyance device 4, a replenishing device 5, an image forming device 6, a discharging device 7, a storage device 9, and a power supply device 19. In this embodiment, the image forming apparatus 100 forms images using a monochrome method.

The paper feeding device 3 accommodates a plurality of recording media S, and feeds the plurality of accommodated recording media S one by one.

The conveyance device 4 conveys the fed recording media S to the discharging device 7.

The replenishing device 5 supplies consumables to the image forming device 6. In this embodiment, the consumable is a toner.

The image forming device 6 executes image forming processing. Specifically, the image forming device 6 forms an image (toner image) on the recording medium S using the consumables. In this embodiment, the image forming device 6 includes an exposure apparatus, a charging apparatus, a photoreceptor drum, a developing apparatus, a cleaning apparatus, a transfer apparatus, and a fixing apparatus, and forms images using an electrophotographic method.

The discharging device 7 discharges the recording medium S on which a toner image is fixed from inside the housing 1 to a discharge tray via a recording medium discharge port.

The storage device 9 stores various data. The storage device 9 is constituted by a storage device and a semiconductor memory. The storage device is configured by, for example, a hard disk drive (HDD) and/or a solid state drive (SSD). The semiconductor memory constitutes, for example, a random access memory (RAM) and a read only memory (ROM). The storage device 9 stores a control program.

The power supply device 19 supplies power to at least some of the parts constituting the image forming apparatus 100.

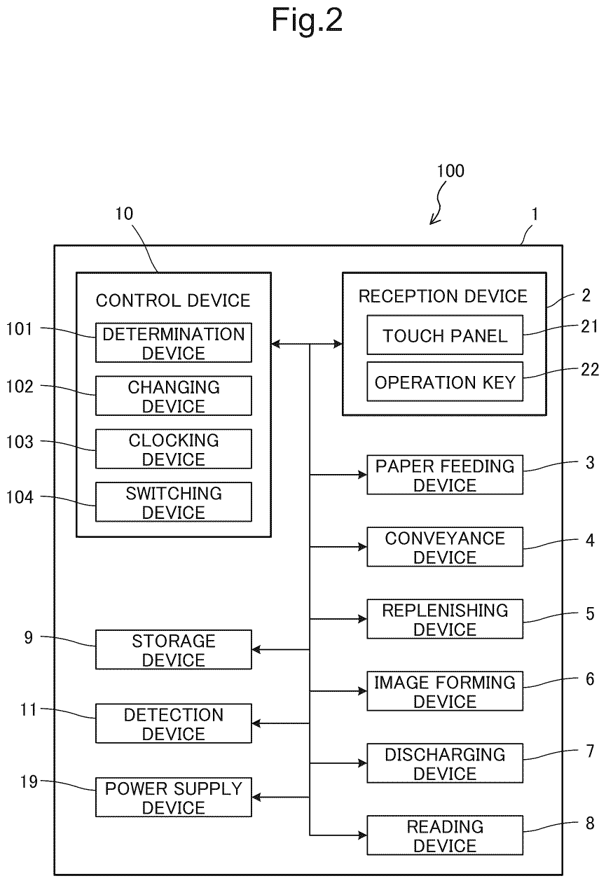

Next, the image forming apparatus 100 will be described in more detail with reference to FIG. 2. FIG. 2 is a block diagram showing the image forming apparatus 100. As shown in FIG. 2, the image forming apparatus 100 further includes a detection device 11, a reception device 2, a reading device 8, and a control device 10.

The detection device 11 detects a detection target. The detection device 11 outputs detection results. The detection results include detection information indicating that the detection target has been detected. The detection device 11 is, for example, a human sensor. The human sensor detects a user as a detection target and generates a detection signal indicating that the user has been detected.

The reception device 2 receives an operation from the user and generates an operation signal indicating the content of the operation received from the user. The reception device 2 generates an operation signal while the user is performing an operation, and does not generate an operation signal while the user is not performing an operation. Operation information includes end information regarding the end of the operation.

The reception device 2 includes a touch panel 21 and a plurality of operation keys 22. The touch panel 21 includes a display and a touch sensor.

The display shows various screens. The various screens include a standby screen and a service screen. The standby screen includes, for example, menu buttons for instructing execution of various processing. The menu buttons include, for example, a button for cancelling processing executed by the image forming apparatus 100, a button for instructing the recording medium S to form an image, and a button for returning to the standby screen. The button for returning to the standby screen is an example of a “specific button.” The service screen is, for example, a screen for changing settings of the image forming apparatus 100. The display is, for example, a liquid crystal display or an organic electroluminescence (EL) display.

The touch sensor detects a touch by a detected object. The touch sensor outputs a position signal indicating a position at which the touch by the detected object is detected. The detected object is, for example, a user's finger. The touch sensor is, for example, a resistive touch sensor. The plurality of operation keys 22 include, for example, a numeric keypad, a start key, and a cancel key.

The reading device 8 reads information regarding the recording medium S from the recording medium S. The reading device 8 is, for example, a scanner. Further, the reading device 8 reads an image formed on the recording medium S. The reading device 8 includes a contact glass, a platen cover, a light emitting device, and an image sensor. The recording medium S is placed on the contact glass. The platen cover covers the contact glass. The light emitting device is, for example, a light emitting diode (LED). The image sensor reads information regarding the recording medium S.

The control device 10 is constituted by a processor such as a central processing unit (CPU). Further, the control device 10 includes an integrated circuit for image forming processing. The integrated circuit for image formation processing is constituted by, for example, an application specific integrated circuit (ASIC). The control device 10 controls the operation of each of the devices of the image forming apparatus 100 by executing a control program.

The control device 10 includes a determination device 101, a changing device 102, a clocking device 103, and a switching device 104. Specifically, the control device 10 functions as the determination device 101, the changing device 102, the clocking device 103, and the switching device 104 by executing the control program stored in the storage device 9.

The switching device 104 switches the state of the image forming apparatus 100 between the first power state and the second power state. For example, when the detection device 11 detects a user, the switching device 104 switches the state of the image forming apparatus 100 from the second power state to the first power state. Furthermore, when the detection device 11 does not detect the user during a first period of time, the switching device 104 switches the state of the image forming apparatus 100 from the first power state to the second power state.

The determination device 101 determines whether the use of the image forming apparatus 100 has ended. Specifically, the determination device 101 determines whether the use of the image forming apparatus 100 has ended based on end information regarding the end of an operation and a detection result of the detection device 11.

The changing device 102 changes the first period of time, during which the state transitions from the first power state to the second power state, to a second period of time. The second period of time is shorter than the first period of time. The first period of time is set in advance by the user and stored in the storage device 9. Further, the second period of time is set in advance by the user and stored in the storage device 9.

Specifically, when the determination device 101 determines that the use of the image forming apparatus 100 has ended, the changing device 102 changes the first period of time, during which the state transitions from the first power state to the second power state, to the second period of time. Thus, when the state transitions from the first power state to the second power state, the accuracy of determination of a transition to the second power state can be improved compared with in a case where the state transitions from the first power state to the second power state using only the human sensor. Furthermore, a period of time required to transition to the second power state can be shortened. In other words, a power saving time can be extended. As a result, unnecessary power consumption can be reduced.

The end information includes at least one of information indicating an instruction for cancellation of processing executed by the image forming apparatus 100, an instruction indicating that a specific button has been operated, and information indicating that processing for forming an image on the recording medium S has ended. Thus, the determination device 101 can obtain detection information indicating that the detection device 11 has detected the user, using the cancellation instruction, the specific button, and the completion of the processing for forming an image on the recording medium S as triggers. As a result, the state of the image forming apparatus 100 can be transitioned from the first power state to the second power state based on the detection of the user at the end of the operation.

Further, the information indicating that the processing for forming an image on the recording medium S has ended includes, for example, information indicating that a job of forming the image has ended.

Further, the determination device 101 determines that the use of the image forming apparatus 100 has ended based on the end information and the detection information detected by the detection device 11 after generating the end information. When the user is detected after generating the information indicating that the use of the image forming apparatus 100 has ended, there is a strong possibility that the user is approaching the image forming apparatus 100 in order to retrieve the recording medium S on which an image has been formed. In this case, the user is not using the image forming apparatus 100 continuously. Thus, the image forming apparatus 100 can be set to be in the second power state. Thus, the accuracy of determination of a transition to the second power state is further improved. As a result, unnecessary power consumption can be further reduced.

Specifically, the determination device 101 determines whether the operation information includes the end information. Then, when the operation information includes the end information, the determination device 101 determines that the use of the image forming apparatus has ended based on the detection information. In other words, the user is approaching the image forming apparatus 100 to retrieve the recording medium S on which an image has been formed, and the user does not use the image forming apparatus 100 continuously. Thus, the image forming apparatus 100 can be set to be in the second power state. Thus, the accuracy of determination of a transition to the second power state is further improved. As a result, unnecessary power consumption can be further reduced.

The clocking device 103 measures a time. Specifically, the clocking device 103 measures a first period of time or a second period of time. Further, the clocking device 103 may measure the first period of time and the second period of time.

Specifically, when the changing device 102 changes the first period of time to the second period of time, the clocking device 103 measures a time until the measurement time reaches the second period of time. Then, when the clocking device 103 measures the second period of time, the switching device 104 switches the state of the image forming apparatus 100 from the first power state to the second power state. The time-out of processing for measuring the second period of time is shorter than the time-out of processing for measuring the first period of time. Thus, a period of time required to shift from a normal mode to a power saving mode can be made shorter than usual. As a result, a period in which the second power state is set can be extended.

Further, when the detection device 11 detects the user while the clocking device 103 is measuring the first period of time, the clocking device 103 may reset the measurement of the first period of time. Further, the clocking device 103 may stop measuring the first period of time during a period in which the measurement of the first period of time is reset and the reception device 2 outputs the operation information to the control device 10. Further, when the detection device 11 detects the user while the clocking device 103 is measuring the second period of time, the clocking device 103 may reset the measurement of the second period of time. Furthermore, the clocking device 103 may stop measuring the second period of time during a period in which the measurement of the second period of time is reset and the reception device 2 outputs the operation information to the control device 10. Furthermore, when the measurement of the second period of time is reset, the changing device 102 may change a period of time, which is required to transition from the first power state to the second power state, from the second period of time to the first period of time.

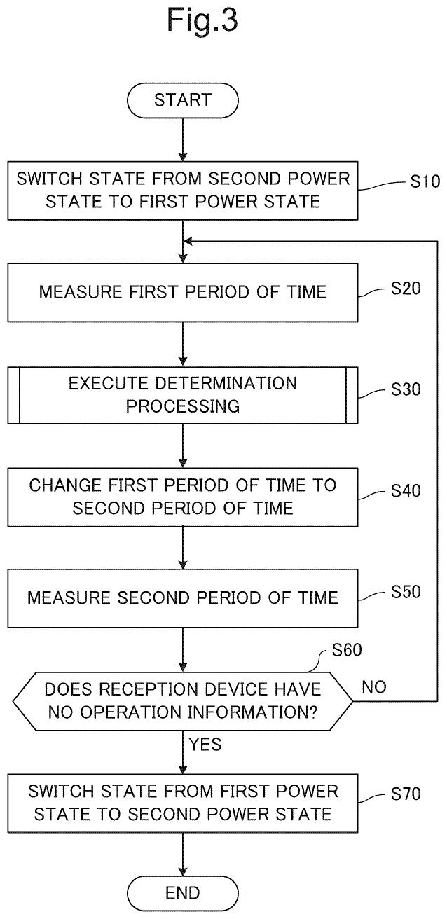

Next, processing executed by the image forming apparatus 100 will be described with reference to FIG. 3. FIG. 3 is a flowchart showing the processing executed by the image forming apparatus 100. The processing executed by the image forming apparatus 100 shown in FIG. 3 includes steps S10 to S70. In FIG. 3, the image forming apparatus 100 is in a state of receiving a job from a user.

In step S10, the switching device 104 switches the state of the image forming apparatus 100 from the second power state to the first power state. The processing proceeds to step S20.

In step S20, the clocking device 103 measures the first period of time. The processing proceeds to step S30.

In step S30, the determination device 101 executes determination processing. Specifically, the determination device 101 determines whether the use of the image forming apparatus 100 has ended. More specifically, the determination device 101 determines whether the use of the image forming apparatus 100 has ended based on end information regarding the end of the operation and a detection result of the detection device 11. The processing proceeds to step S40.

In step S40, the changing device 102 changes the first period of time, which is required to transition from the first power state to the second power state, to the second period of time. The processing proceeds to step S50.

In step S50, the clocking device 103 measures the second period of time. The processing proceeds to step S60.

In step S60, the control device 10 determines whether the reception device 2 has generated operation information. When the reception device 2 generates the operation information (No in step S60), the processing returns to step S20. When the reception device 2 has not generated the operation information (Yes in step S60), the processing proceeds to step S70.

In the case of Yes in step S60, the switching device 104 switches the state of the image forming apparatus 100 from the first power state to the second power state in step S70. The processing ends.

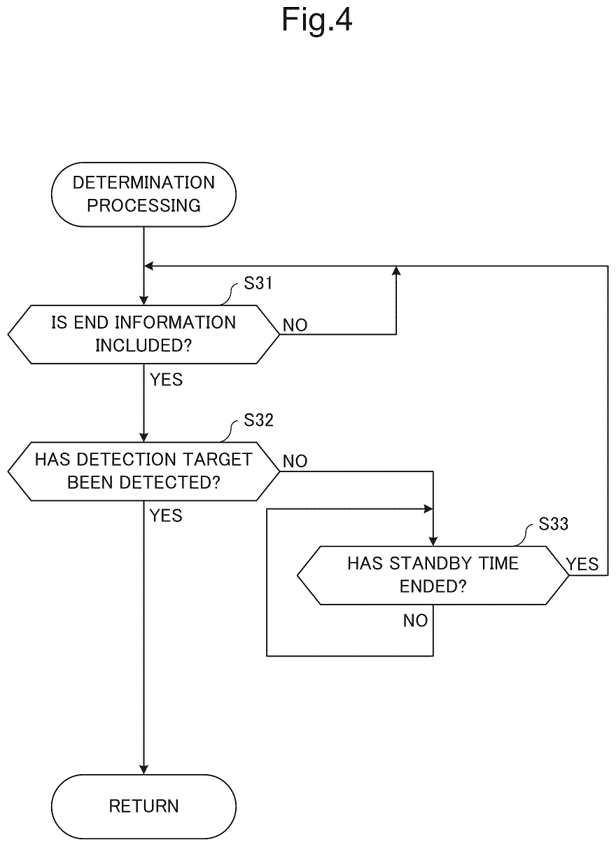

Next, determination process executed by the image forming apparatus 100 will be described with reference to FIG. 4. FIG. 4 is a flowchart showing the determination processing executed by the image forming apparatus 100. The determination processing executed by the image forming apparatus 100 shown in FIG. 4 includes steps S31 to S33.

In step S31, the determination device 101 determines whether the operation information includes end information. When the operation information does not include end information (No in step S31), step S31 is repeated in the processing. When the operation information includes end information (Yes in step S31), the processing proceeds to step S32.

In the case of Yes in step S31, the determination device 101 determines in step S32 whether a detection target has been detected based on a detection result of the detection device 11. When the detection target is detected (Yes in step S32), the processing returns to the flowchart shown in FIG. 3. When no detection target has been detected (No in step S32), the processing proceeds to step S33.

In the case of No in step S32, the control device 10 determines in step S33 whether a standby time until a detection target is detected has ended. When the standby time has ended, the processing returns to step S31. When the standby time has not ended, the processing returns to step S33.

Incidentally, in the above-described general image forming apparatus, the detection unit detects a detection target, which is an object, so that the image forming apparatus is made to transition to a second power state. For this reason, the image forming apparatus cannot accurately determine the absence of a detection target. For this reason, unnecessary power is consumed before the image forming apparatus is made to transition to the second power state.

On the other hand, according to the image forming apparatus 100 of this embodiment, unnecessary power consumption can be reduced.

The embodiment of the disclosure has been described above with reference to the drawings. However, the disclosure is not limited to the above-described embodiment, and can be implemented in various forms without departing from the spirit thereof. The drawings mainly show each component schematically for ease of understanding, and the thickness, length, number, spacing, and the like of each component shown in the diagrams may differ from the actual one for convenience of drawing. Further, the speed, material, shape, dimensions, and the like of each component shown in the above-described embodiment are merely examples and are not particularly limited, and various changes can be made without substantially departing from the configuration of the disclosure.

The disclosure provides an image forming apparatus and has industrial applicability.

While the disclosure has been described in detail with reference to the embodiments thereof, it would be apparent to those skilled in the art the various changes and modifications may be made therein within the scope defined by the appended claims.

What is claimed is:

1. An image forming apparatus capable of switching a state of the image forming apparatus between a first power state and a second power state in which less power is consumed than in the first power state, the image forming apparatus comprising:
a detection device that detects a detection target;
a reception device that receives an operation from the detection target and generates operation information indicating an operation content of the detection target; and
a control device that includes a processor and functions as a determination device and a changing device by the processor executing a control program, the determination device determining whether use of the image forming apparatus has ended, and the changing device changing a first period of time, which is required to transition from the first power state to the second power state, to a second period of time that is shorter than the first period of time, wherein
the operation information includes end information regarding end of the operation,
the determination device determines whether the use of the image forming apparatus has ended based on the end information and a detection result of the detection device, and
when the determination device determines that the use of the image forming apparatus has ended, the changing device changes the first period of time to the second power state, to the second period of time.

2. The image forming apparatus according to claim 1, wherein
the detection result includes detection information indicating that the detection target has been detected, and
the determination device determines that the use of the image forming apparatus has ended based on the end information and the detection information detected by the detection device after generating the end information.

3. The image forming apparatus according to claim 1, wherein
the detection result includes detection information indicating that the detection target has been detected, and
the determination device determines whether the operation information includes the end information, and determines that the use of the image forming apparatus has ended based on the detection information when the operation information includes the end information.

4. The image forming apparatus according to claim 2, wherein
the control device further functions as a clocking device that measures a time, and a switching device that switches the state of the image forming apparatus between the first power state and the second power state,
when the changing device changes the first period of time to the second period of time, the clocking device measures a time until the measurement time reaches the second period of time, and
when the clocking device measures the second period of time, the switching device switches the state of the image forming apparatus from the first power state to the second power state.

5. The image forming apparatus according to claim 4, wherein
the end information includes at least one of information indicating an instruction to cancel the process executed by the image forming apparatus, an instruction indicating that a specific button has been operated, and information indicating that the process of forming an image on a recording medium has ended.

6. The image forming apparatus according to claim 4, wherein, when the detection device detects the detection target while the clocking device is measuring the second period of time, the clocking device resets measurement of the second period of time, and stops the measurement of the second period of time during a period in which the reception device generates the operation information after the reset.
